(19) United States
(12) Patent Application Publication
(10) Pub. No.: US 2018/0143342 A1
(43) Pub. Date: May 24, 2018

(54) WEARABLE METAL DETECTOR

(71) Applicants: Lloyd Stephen Riggs, Auburn, AL (US); Roshni Mehta Sherbondy, Burke, VA (US); Aubrey Nathan Beal, Huntsville, AL (US)

(72) Inventors: Lloyd Stephen Riggs, Auburn, AL (US); Roshni Mehta Sherbondy, Burke, VA (US); Aubrey Nathan Beal, Huntsville, AL (US)

(21) Appl. No.: 15/795,401

(22) Filed: Oct. 27, 2017

Related U.S. Application Data
(60) Provisional application No. 62/496,702, filed on Oct. 27, 2016.

(51) Int. Cl. G01V 3/10

(52) U.S. Cl. CPC G01V 3/104; G08B 7/00

(57) ABSTRACT

A wearable metal detector. The wearable metal detector includes a garment configured to be worn by a user. A metal detector is attached to the garment. A notification device is operable to receive a signal from the metal detector and then produce a notification to the user.

### CROSS-REFERENCE TO RELATED APPLICATION

This application claims the benefit of priority of U.S. provisional application No. 62/496,702, filed Oct. 27, 2016, the contents of which are herein incorporated by reference.

### BACKGROUND OF THE INVENTION

The present invention relates to a wearable metal detector and, more particularly, to a wearable metal detector that transmits an alert to a user wearing the metal detector or a remote user.

Law enforcement and military personnel desire a means to initially detect and/or further investigate a potential assailant carrying a concealed weapon or a person carried bomb in a crowd of people. Groups of people can be found for example at special events, schools, shopping areas, transportation venues, city centers, meetings and gatherings. These and other locations where people gather offer opportunities to target individuals or large crowds.

Person carried bombs often include nails, ball bearings and/or other metallic shrapnel that are intended to maximize impact range, lethality and death toll. Standard handheld metal detectors can detect even small quantities of metal found in handguns or other weapons. Unfortunately, these detectors cannot be used in their current format and design without alerting the clandestine individual that they are being searched.

As can be seen, there is a need for a wearable concealed metal detector so that only the desired party or parties are alerted to the presence of nearby metallic objects.

### SUMMARY OF THE INVENTION

In one aspect of the present invention, a wearable metal detector comprises: a garment configured to be worn by a user; a metal detector attached to the garment; and a notification device operable to receive a signal from the metal detector and produce a notification to the user.

In another aspect of the present invention, a wearable metal detector comprises: a garment configured to be worn by a user; a metal detector attached to the garment, the metal detector comprising: a transmitting coil; at least one receiving coil; a power source; and a circuit board electrically connected to the power source, the transmitting coil and the at least one receiving coil, wherein the circuit board supplies electrical current to the transmitting coil and processes signals picked up by the receiving coils; and a notification device operable to receive a signal from the circuit board and produce a notification to the user.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention;

FIG. 2 is a rear perspective view of an embodiment of the present invention;

FIG. 3 is a front view of an embodiment of the present invention showing an opened garment;

FIG. 4 is a schematic view of an operation of an embodiment of the present invention;

FIG. 5 is a schematic view of a transmitter coil pulse train;

FIG. 6 is a flowchart of a detection algorithm of an embodiment of the present invention;

FIG. 7 is a diagram of a characteristic analog-to-digital converter (ADC) reading curve;

FIG. 8 is a diagram of a ADC reading with positive and negative deflections;

FIG. 9 is a diagram of a characteristic ADC curve with sampling points;

FIG. 10 is a diagram of a characteristic ADC curve with a detection threshold window;

FIG. 11 is a diagram of a characteristic ADC curve, illustrating a positive deflection;

FIG. 12 is a diagram of a characteristic ADC curve, illustrating a negative deflection;

FIG. 13 is a diagram of a characteristics ADC curve, illustrating background compensation; and

FIG. 14 is a diagram of a characteristic ADC curve, illustrating signal clipping.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence of addition of one or more other features, steps, operations, elements, components, and/or thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Common principles of metal detection begin by the means of electromagnetically stimulating a conductive, metallic object as to induce localized currents known as eddy-currents. This process involves time-varying magnetic fields that induce loops of electrical current in conductors subjected to this field. This phenomenon is described by Faraday's law of induction, and constitutes sets of transmission waveforms. These transmissions are used to excite eddy-currents in detectable objects and may be continuous in time, continuous-wave (CW), or discontinuous in time such as the pulses used in pulse-induction (PI) detection.

To complete the metal detection process, the induced eddy-currents must be sensed. Sensing techniques based on Lenz's law are commonly employed. Lenz's law describes a new magnetic field that is created by the aforementioned eddy-currents. This new magnetic field opposes the magnetic field of CW transmitted waveforms. This counteraction leads to changes in frequency, phase and/or amplitude that provides means for detection. PI transmissions need sensitive electronics and coils to sense the small magnetic fields given by Lenz's law in between pulses or during the pulses' decay. This often involves a sensitive receiver because the magnitude of these eddy-currents may be notably small and their resulting magnetic field may translate to very modest voltage-mode sensor data in 10E-6-10E-3 V range.

In both cases of CW and PI transmission, receiver sensor data may be analyzed in multiple domains. Examples of received data signal processing may include filtering and/or analysis in the time-domain, frequency-domain, phase-domain and even using wavelet transforms, neural networks, machine learning algorithms or other combinations signal processing techniques.

Generally, this invention may be realized using continuous and/or pulsed transmission. Similarly, a wide range of sensing and data processing techniques is compatible with this invention. Successful metal detection may be achieved by using various receiver topologies, current or voltage mode sensors and any transform or signal processing technique that allows for improvement in the detection of Lenz's law produced eddy-currents due to the excitation of an object from a transmitted electromagnetic field.

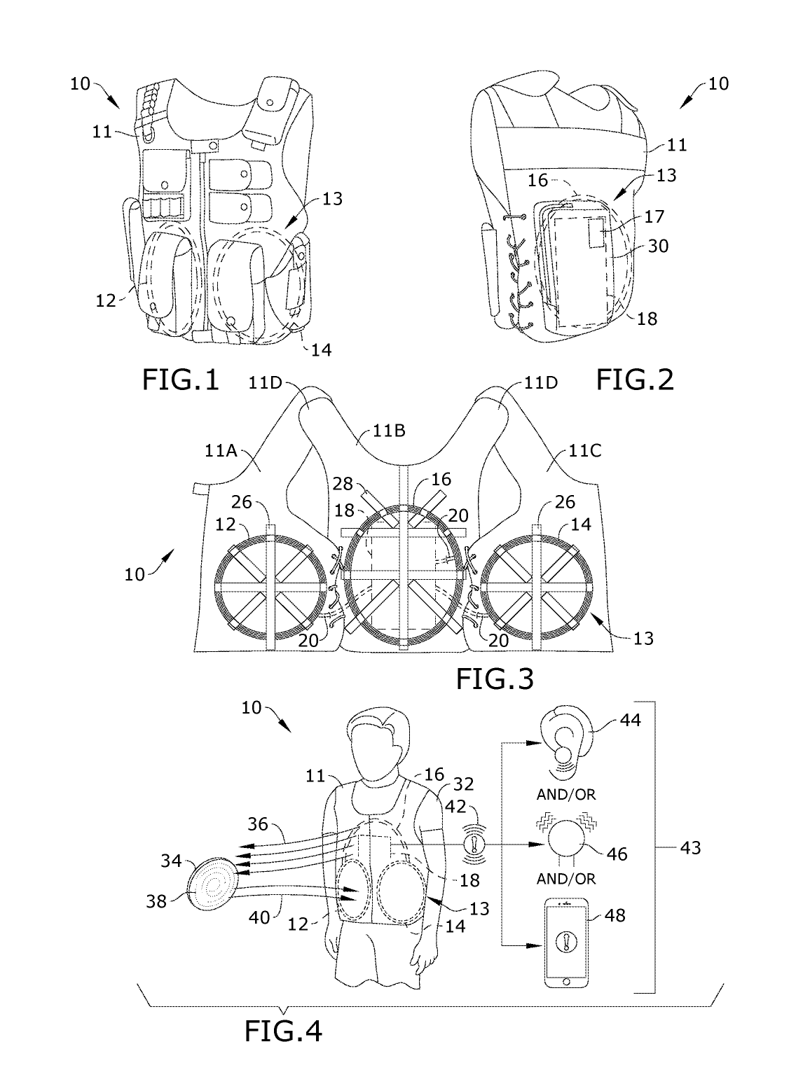

Referring to FIGS. 1 through 4, the present invention includes a wearable metal detector. The wearable metal detector includes a garment 10 configured to be worn by a user 32. A metal detector 13 is attached to the garment 10. A notification device 43 is operable to receive a signal 42 from the metal detector 13 and then produce a notification to the user 43.

As mentioned above, the metal detector 13 may use continuous and/or pulsed transmission. In certain embodiments, the metal detector includes a transmitting coil 16, at least one receiving coil 12, 14, a power source 17, such as a battery, and a circuit board 18. Electrical wiring 20 electrically connects the power source 17, the transmitting coil 16 and the receiving coil 12, 13 to the circuit board 18. The circuit board 18 supplies electrical current to the transmitting coil 16, processes signals picked up by the receiving coils 12 and sends the signal to the notification device 43. The notification device 43 then notifies the user 32.

The garment 10 of the present invention may fit around a user's upper or lower body. For example, the garment 10 may include a vest 11, a shirt, pants, jacket and the like. As illustrated in the Figures, the present invention may be used with a vest 11. The vest 11 may include a right front portion 11a configured to cover the right portion of a user's chest, a left front portion 11c configured to cover the left portion of a user's chest, a back portion 11b configured to cover the user's back, and shoulder straps 11d configured to fit around a user's shoulders and attach the right front portion 11a and the left front portion 11c to the back portion 11b. In certain embodiments, a first receiving coil 12 is attached to an inner surface of the right front portion 11a by retaining straps 26, a second receiving coil 14 is attached to an inner surface of the left front portion 11c by retaining straps 26 and the transmitting coil 16 is attached to the inner surface of the back portion 16 by training straps 26. Further, the circuit board 18 and battery 17 may be stored within an internal or external pocket 30 of the vest 11. Attaching the coils 12, 14, 16 to the inner surface of the vest 11 and containing the circuitry within a pocket 30 conceals the metal detector 13 from other people.

The notification device 43 may include a speaker 44, a vibrator 46, a computer 48 or other electronic device that notifies the user 32 that metal has been detected. In certain embodiments, the speaker 44 may be part of an ear bud, which is sized to fit in the user's ear. The speaker 44 receives an audio signal from the circuit board 30 and produces sound. In certain embodiments, the speaker 44 may be an electromechanical transducer that produces sound. The speaker 44 may be wired or may be wireless and may wirelessly receive the signal 42 from the metal detector 13. The vibration device 46 may receive the signal 42 from the metal detector 13 and vibrate, thereby notifying the user 32. The vibration device 46 may be wired or may be wireless and may wirelessly receive the signal 42 from the metal detector 13. In certain embodiments, an amount of vibration/sound may indicate an amount of metal in vicinity. For example, a louder sound or a stronger vibration may indicate a larger amount of metal and a lower sound or a weaker vibration may indicate a smaller amount of metal.

The computer 48 of the present invention may include a smart device with a touch screen interface. When the smart device receives, the signal 42, the smart device may either produce a vibration or a noise from a built-in speaker. The smart device may include a software application (app) loaded on its memory. The smart device wirelessly communicates with circuit board 30 of the metal detector 13. The app may allow the user to set metal detector operating parameters, monitor battery level and perform other “housekeeping” functions. The touchscreen interface may present the output of the metal detector in graphical format as an x-y plot or bar graph yielding an alternative way of warning the user of the presence of metal. In certain embodiments, the smart device is triggered by detection to communicate (i.e. send a text message) to a remote location to initiate some other response.

A pulse-induction metal detector, as the name implies, depends on short pulses of current driven into the transmitting coil. Specifically, as shown in FIG. 5 the current in the transmitting coil is caused to increases exponentially for a period of time equal to approximately 9 ms. At the end of this 9 ms period the current has increased to a value of approximately 6 amps. Next, through special design, the current is forced to decreases linearly from its peak value to zero amps in approximately 100 μs. This current is extinguished abruptly without oscillations. The detection process, which is described below, occurs between transmitter pulses. The current is flowing through the transmitting coil for only a small percentage of this period resulting in a current duty cycle of about 9%. The detection process occurs during the period of time when the transmitter current pulse is off.

As shown in FIGS. 3 and 4, there are two receiver coils 12, 14 in close proximity to the transmitting coil 16 resulting in strong magnetic coupling between the transmitting coil 16 and receiving coils 12, 14. The voltage coupled into the receiver coils 12, 14 from the transmitter coil 16 is large during the period of time when current is flowing in the transmitter coil 16 to produce a transmitter current 36 but then diminishes to approximately zero during the period of time after the transmitter current 36 is extinguished and before the start of the next transmitter current pulse. In accordance with Faraday's law of induction, eddy currents 38 are induced into nearby metallic objects 34 by the time changing magnetic field radiated by the current flowing in the transmitter coil 16. Typically, these eddy currents 38 decay slowly and can persist long after the transmitter current 36 is off. A voltage 40 is induced into each receiver coil 12, 14 due to the magnetic field radiated by the eddy currents 38. This eddy current voltage induced in the receiver coils 12, 14 typically lasts much longer than the voltage directly coupled into the receiver coils 12, 14 by the transmitter current 36. By amplifying and sampling the receiver coil voltage at a point in time after the transmitter current 36 is turned off (and before the start of the next current pulse) the eddy current voltage can be detected indicating the presence of a nearby metallic object 34.

The voltage induced in the receiver coils is subtracted, amplified, filtered, and sampled. If a metallic object is symmetrically located with respect to the receiver coils the voltage induced into each coil is the same and so their difference is zero. On the other hand if a metallic object is closer to one receiver coil than the other the received voltage is positive or negative depending on weather the right or left receiver coil is closest to the object. A change in receiver coil voltage from positive to negative or conversely from negative to positive occurs when a metallic object is moved from right to left or conversely from left to right in front of or behind the wearable metal detector.

Electromagnetic interference, thermal and/or other types of noise may inevitably contaminate the receiver coil voltages. In certain embodiments, the noise is reduced by low pass filtering and averaging. Nevertheless, some noise remains as a component of the received signal. As described in greater detail below, it is preferable to develop a robust method of detecting the receiver coil signals in the presence of noise.

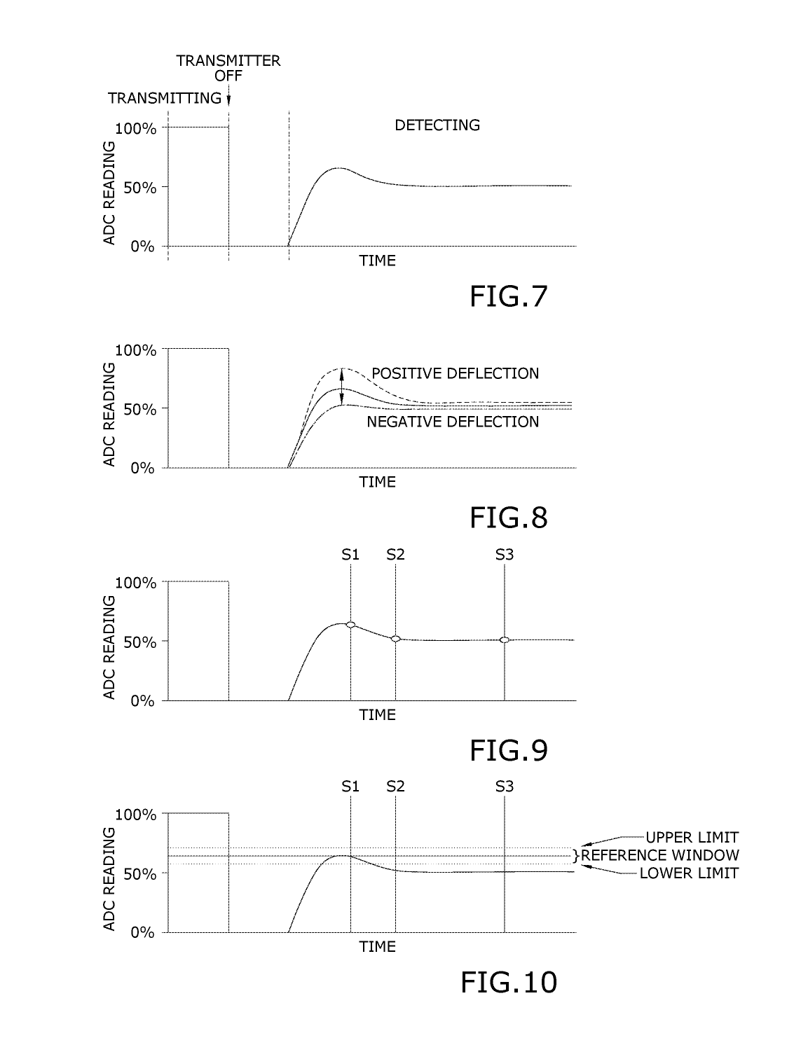

The analog receiver coil voltage is sampled using an analog-to-digital converter (ADC). During the period of time when the transmitter current pulse is exponentially increasing the ADC is full scale (100%) while during the period of time the transmitter current is linearly decreasing the ADC is 0%. In the absence of a metallic object, and after the transmitter current turns off, the ADC settles to a middle value near 50%. This is depicted in FIG. 7. FIG. 8, on the other hand, indicates that a metallic object near one of the receiving coils produces a positive deflection of the ADC reading while an object near the other coil produces a negative deflection. FIG. 9 shows three possible sample values S1, S2, and S3. The sample ADC values at S1, S2 and S3 is different (larger or smaller) when a metallic object is present compared to when a metallic object is not present. A positive or negative difference indicates the presence of an object.

FIG. 10 indicates that even in the absence of a nearby metallic object the ADC value with vary randomly about its average value. Because of unavoidable noise, the receiver coil voltage sampled at S1, S2, or S3 has a random voltage component added to the systematic voltage component due to the object eddy currents. As such, the receiver coil voltage usually lies somewhere in the shaded area indicated in FIG. 10. If the total receiver coil voltage ADC value, due to the random plus the systematic component, exceeds the upper limit or is below the lower limit indicated in FIG. 10 then it is highly likely, but not absolutely certain, that a metallic object is near the receiver coils. Anytime an ADC reading at S1, S2, or S3 exceeds the upper or lower limit (is outside the gray area indicated in FIG. 10) an alarm is initiated as a metallic object is likely present. However, because of the random nature of noise, false alarms are possible.

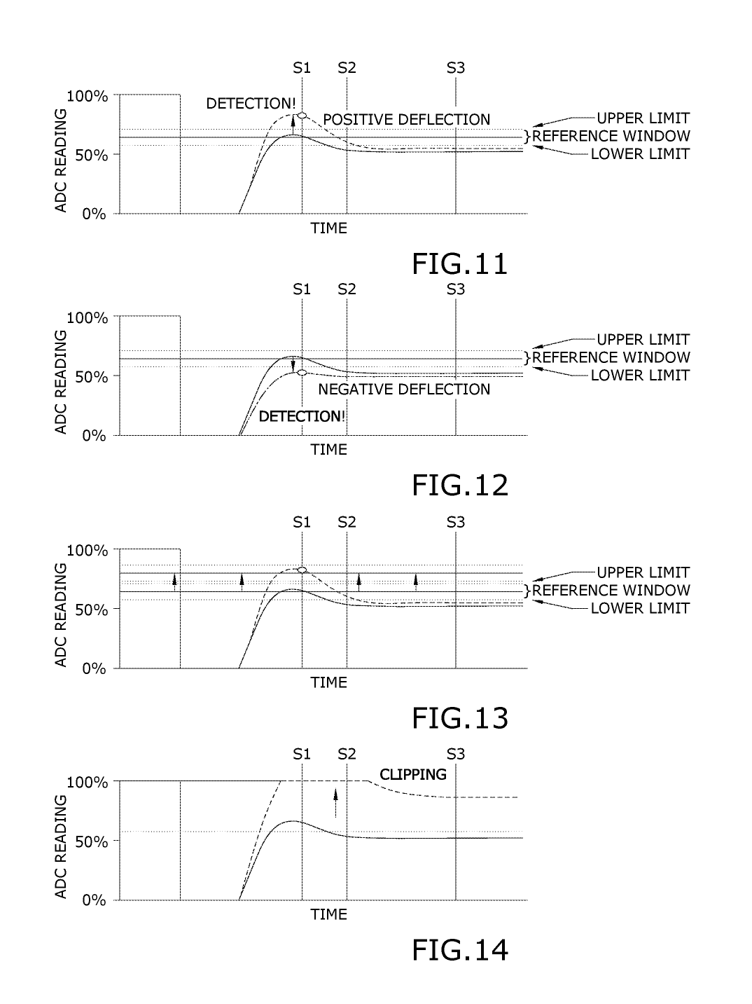

FIG. 11 illustrates a situation where, due to the presence of a metallic object, there is a positive deflection of the ADC value at the sample point S1. The deflection is of sufficient magnitude so as to be greater than the upper limit of the gray area and would therefore constitute a detection resulting in an alarm. FIG. 12 illustrates a similar situation except that there is a negative deflection of the ADC value below the lower limit that results in an alarm.

Another unique feature of the present invention is illustrated in FIG. 13. If a metallic object passes by the receiver coils there is a momentary deflection of the ADC reading at the sample point S1 that results in a momentary alarm. However, if a metallic object remains near the receiver coils, for several seconds, then the position of the reference window is reset causing the alarm to terminate. In this way the wearable metal detector adjusts to metallic objects that are fixed with respect to the receiver coils. This is important since the user of the wearable metal detector may have a ring, belt buckle, necklace, etc. or some other metallic object that would otherwise elicit a false positive alarm. The wearable metal detector may be described as AC-coupled to its environment. (AC is an acronym for alternating current and indicates that only an electronic signal that changes with time will elicit a response.)

FIG. 14 illustrates a condition wherein the presence of a relatively large amount of metal near the receiver coils has caused a full scale ADC reading. This condition is referred to as saturation or clipping and as a consequence the wearable metal detector no longer functions as intended. As soon as the large metallic object is removed the wearable metal detector resumes normal functioning.

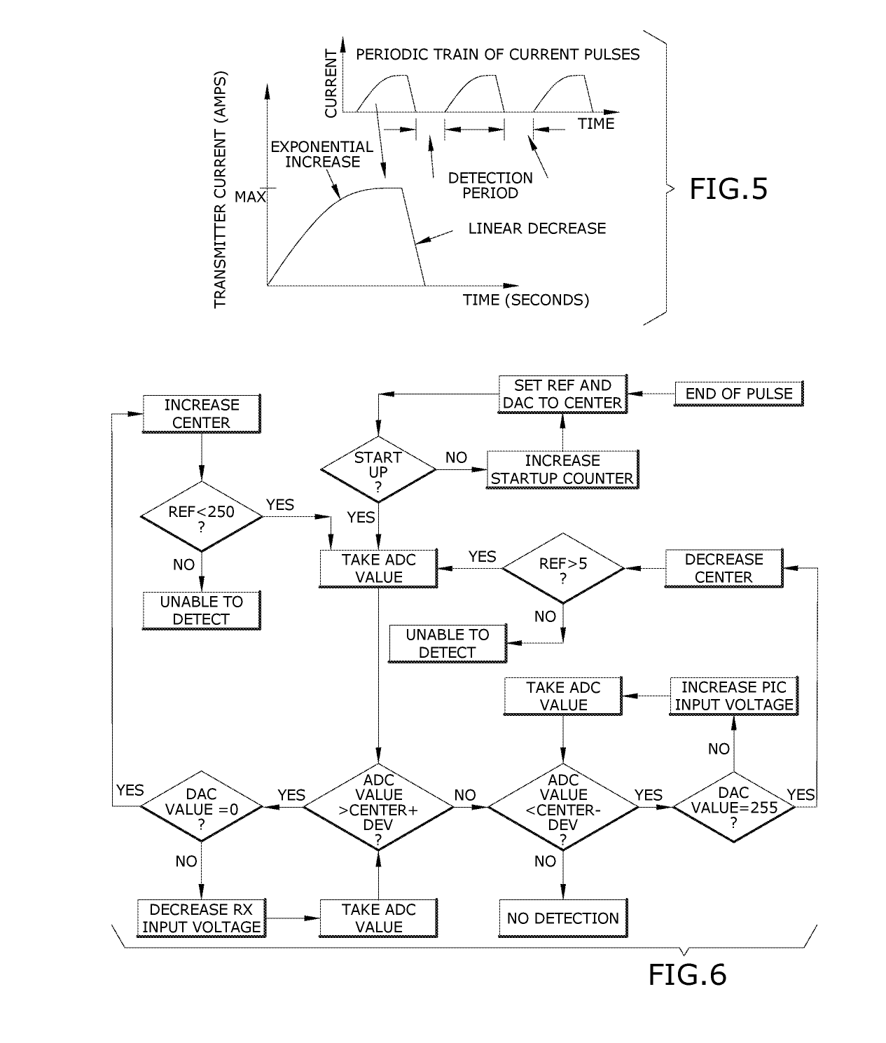

FIG. 6 presents a flow chart of the detection algorithm employed in an embodiment of the present invention. Detection is triggered by the end-of-the-transmitter pulse. The routine begins by initiating a startup subroutine. This routine sets a reference value and a DAC control voltage to a stable average that is observed by the ADC. For example, an 8 bit system would have 256 values ranging from 0 to 255 and the ADC may observe any value within this range that corresponds to the presence of metallic objects that are fixed with respect to the receiver coils. The observed ADC value is referred to as “center” and constitutes a starting point for calibration.

Once the startup counter is satisfied, a DC value is taken and compared to the previously established center value with some added hysteresis denoted by “dev” (deviation). If the measured ADC value is greater or less than this limit, detection is announced. The algorithm then adjusts the DAC control voltage until the detection condition is no longer met. If the DAC control voltage reaches its extreme value, the center is adjusted allowing further range of operation.

Once the DAC control voltage and the center value have been maximally adjusted, the algorithm sets a flag that indicates that the ADC value is out of range. It should be noted that the combination of this algorithm with electronic inverting hardware causes the DAC control voltage to be lowered as the center value is increased and vice versa. If non-inverting electronic hardware were employed the reverse condition would prevail.

The resulting detection algorithm allows the measured ADC value used in announcing a detection to have extended range as well as auto-zeroing stationary interfering metallic objects. It should be noted however, that interferences are announced as a false detection for one cycle as the algorithm makes adjustments. The conclusion is that the system reacts to short-term changes in the receiver coil output voltages while zeroing out long-term intrusions by interfering objects.

It should be understood, of course, that the foregoing relates to exemplary embodiments of the invention and that modifications may be made without departing from the spirit and scope of the invention as set forth in the following claims.

What is claimed is:

1. A wearable metal detector comprising:
a garment configured to be worn by a user;
a metal detector attached to the garment; and
a notification device operable to receive a signal from the metal detector and produce a notification to the user.

2. The wearable metal detector of claim 1, wherein the metal detector is a pulse induction metal detector.

3. The wearable metal detector of claim 1, wherein the metal detector comprises:
a transmitting coil;
at least one receiving coil;
a power source; and
a circuit board electrically connected to the power source, the transmitting coil and the at least one receiving coil, wherein
the circuit board supplies electrical current to the transmitting coil, processes signals picked up by the at least one receiving coil and sends the signal to the notification device.

4. The wearable metal detector of claim 3, wherein the circuit board amplifies signals picked up by the receiving coils.

5. The wearable metal detector of claim 3, wherein the garment is a vest comprising a right front portion, a left front portion, a back portion and shoulder straps connecting the back portion to the right front portion and the left front portion.

6. The wearable metal detector of claim 5, wherein the at least one receiving coil comprises a first receiving coil attached to the right front portion and a second receiving coil attached to the left front portion, wherein the transmitting coil is attached to the back portion.

7. The wearable metal detector of claim 1, wherein the notification device is a speaker and the signal is an audio signal.

8. The wearable metal detector of claim 7, wherein the speaker is part of an ear bud sized to fit in the user's ear.

9. The wearable metal detector of claim 1, wherein the notification device is a vibrator.

10. The wearable metal detector of claim 1, wherein the notification device is a computer, wherein the signal is a wireless signal.

11. The wearable metal detector of claim 10, wherein the computer is a smart device comprising a touch screen interface.

12. A wearable metal detector comprising:
a garment configured to be worn by a user;
a metal detector attached to the garment, the metal detector comprising:
a transmitting coil;
at least one receiving coil;
a power source; and
a circuit board electrically connected to the power source, the transmitting coil and the at least one receiving coil, wherein
the circuit board supplies electrical current to the transmitting coil and processes signals picked up by the at least one receiving coil; and
a notification device operable to receive a signal from the circuit board and produce a notification to the user.

13. The wearable metal detector of claim 12, wherein the garment is a vest comprising a right front portion, a left front portion, a back portion and shoulder straps connecting the back portion to the right front portion and the left front portion.

14. The wearable metal detector of claim 13, wherein the at least one receiving coil comprises a first receiving coil attached to the right front portion and a second receiving coil attached to the left front portion, wherein the transmitting coil is attached to the back portion.
